(19) United States
(12) Patent Application Publication
(10) Pub. No.: US 2025/0167636 A1
(43) Pub. Date: May 22, 2025

(54) EXTERNALLY EXCITED SYNCHRONOUS MACHINE, MOTOR VEHICLE AND METHOD FOR OPERATING AN EXTERNALLY EXCITED SYNCHRONOUS MACHINE

(71) Applicant: AUDI AG, Ingolstadt (DE)

(72) Inventor: Daniel RUPPERT, Lenting (DE)

(21) Appl. No.: 18/938,718

(22) Filed: Nov. 6, 2024

(30) Foreign Application Priority Data
Nov. 16, 2023 (DE) 102023131907.8

(51) Int. Cl. H02K 11/21; H02K 11/042; H02K 19/02

(52) U.S. Cl. CPC H02K 11/21; H02K 11/042; H02K 19/02; H02K 2213/09

(57) ABSTRACT

An externally excited synchronous machine is provided having a stator and a rotor rotatable relative to the stator, wherein the rotor has an exciter winding for providing a rotor field during operation of the synchronous machine, wherein the synchronous machine has an inductive transmission system for wirelessly transmitting electrical power to the exciter winding for operating the exciter winding, wherein the synchronous machine further has a capacitive transmission arrangement with a fixed first transmission device or means and a second transmission device or means opposite the first transmission device or means and arranged on an end face of the rotor for data transmission between a rotor-external control device of the externally excited synchronous machine and a rotor-side control unit. A motor vehicle and a method for operating the externally excited synchronous machine is also provided.

### BACKGROUND

### Technical Field

The present disclosure relates to an externally excited synchronous machine, having a stator and a rotor rotatable relative to the stator, wherein the rotor has an exciter winding for providing a rotor field during operation of the synchronous machine, wherein the synchronous machine has an inductive transmission system for wirelessly transmitting electrical power to the exciter winding for operating the exciter winding. In addition, the present disclosure further relates to a motor vehicle and a method for operating an externally excited synchronous machine.

### Description of the Related Art

In electrified motor vehicles, such as, for example, electric motor vehicles and hybrid vehicles, synchronous machines are often used as drive machines (traction machines). A special embodiment of the synchronous machine is the so-called externally excited synchronous machine.

In contrast to the permanently excited synchronous machine, this type of machine does not require any magnetic materials on the rotor and generates the rotor magnetic field through an energized exciter winding in the rotor. This has the advantage of additional degrees of freedom in the control and design of the externally excited synchronous machine. This can increase efficiency and performance. In known solutions, the exciter winding is energized either via slip ring contacts or contactlessly by transmitting the power via an inductive transmission system with an inductive rotary transformer. The inductive power transmission system includes a fixed inverter, an inductive rotary transformer, a rotating rectifier and a filter for smoothing the excitation current. By way of the transmission system, an electric direct voltage can be generated without contact to drive an excitation current in the exciter winding of the rotor of the externally excited synchronous machine.

The excitation current is controlled by controlling the fixed inverter by way of appropriate control information. This information is calculated using complex and time-consuming estimation algorithms. During operation, this can lead to large deviations or inaccuracies in the provision of the correct excitation current. The strong temperature dependence of the rotor resistance in particular can lead to large deviations in the models used by the estimation algorithms, so that an incorrect excitation current is provided at certain operating points. This leads to an incorrect torque, which can in particular violate functional safety requirements. In summary, a high level of computational effort is required for the estimation algorithms and large safety buffers must be set with regard to incorrect excitation currents and overdimensioning must be used (poorer efficiency of the overall system).

In this type of control, sensor data from a rotor position sensor, which describes the angular position of the rotor, is used in particular. The precise rotor position determined in this way is used for efficient and dynamic torque control. Known rotor position sensors include, for example, resolvers that use inductive measuring methods and sensors that use the magnetoresistive effect (TMR).

In order to improve other applications, it was proposed to enable communication with a control unit in a rotating element, for example to transmit measurement data from the rotating element to an external control device.

The document WO 2018/015 774 A1 discloses a device for measuring the temperature or other physical quantities, wherein the transmission of signals and energy takes place without contact. Contactless energy transmission is achieved through inductive coupling, contactless signal transmission through differential capacitive coupling. Applications are described for a disc brake and a clutch element.

### BRIEF SUMMARY

Embodiments of the present disclosure provide an externally excited synchronous machine which is improved with regard to material and/or calculation effort.

The present disclosure described herein provides an externally excited synchronous machine, a motor vehicle and a method for operating an externally excited synchronous machine.

In an externally excited synchronous machine of the type mentioned at the outset, the present disclosure provides that the synchronous machine may have a capacitive transmission arrangement with a fixed first transmission device or means and a second transmission device or means opposite the first transmission device or means and arranged on an end face of the rotor for data transmission between a rotor-external control device of the externally excited synchronous machine and a rotor-side control unit. In some embodiments, the capacitive transmission arrangement may be designed as a rotor position sensor for determining an angular position of the rotor.

As is generally known, an appropriately dimensioned inductive transmission system is used for power transmission. The inductive transmission system may include a fixed inverter, for example on the stator side, an inductive rotary transmitter and a rotor-side rectifier. A smoothing filter may also be provided on the rotor side. These components can be controllable by the control device or the control unit in order to provide a specific excitation current in the exciter winding.

According to the present disclosure, it is proposed to supplement the inductive rotary transmitter in the externally excited synchronous machine with a capacitive channel. Unlike the inductive channel for transmitting power or energy, only data signals are transmitted via the capacitive channel, so that it can be designed to be comparatively small. The capacitive transmission of data signals increases the robustness of the overall system, as it is not susceptible to electromagnetic interference. Such capacitive data transmission has proven to be particularly advantageous with regard to an externally excited synchronous machine.

In some embodiments, the rotor may have at least one rotor sensor, wherein the control unit is designed to transmit sensor data from the at least one rotor sensor to the control device via the capacitive transmission arrangement, and/or if the control device is designed to transmit current information for providing the excitation current to the control unit via the capacitive transmission arrangement. In this case, at least one of the at least one rotor sensor may be selected from the group comprising a rotor temperature sensor, a rotor current sensor and a rotor voltage sensor. The rotor current and the rotor voltage are expediently measured at the exciter winding so that the rotor current corresponds to the excitation current actually present. Since the control device is expediently designed to regulate the excitation current using the sensor data, it may be provided that sensor data, such as a rotor temperature and/or a rotor current and/or a rotor voltage, are picked up by the at least one rotor sensor, transmitted to the control device by the control unit via the capacitive transmission arrangement and used by the control device to regulate the excitation current. This can be done by appropriately controlling the inverter of the inductive transmission system and/or by appropriately transmitting current information to the control unit. As a result, a closed control loop is created through the rotor, in which the control device determines the excitation current to be set by controlling the inverter, corresponding excitation power is transported into the rotor by the inductive transmission system, the rotor state resulting at least in part therefrom is measured, and the corresponding sensor data is transmitted to the control device by the capacitive transmission system in order to be used for the next control step.

In one embodiment, the signals rotor current, rotor voltage and rotor temperature may be detected as sensor data on the rotor side and transmitted via the control unit, such as an integrated microcontroller, from the rotating secondary side to the fixed primary side (stator side), i.e., to the rotor-external control device. In general, it is therefore possible to detect sensor data directly for control and to increase the control or efficiency of the externally excited synchronous machine, such as in the case of a motor vehicle of the entire drive system. The precise measurement of the sensor data also eliminates the need for complex estimation algorithms for estimating the corresponding information. The robustness of the externally excited synchronous machine is increased because no more deviations in the excitation current are to be expected. This procedure also meets all requirements for functional safety.

The following advantages can be achieved by directly measuring sensor data in the rotor and making it available through capacitive data transmission and use outside the rotor: Computationally intensive estimation algorithms for estimating the excitation current and/or rotor state can be omitted, so that the control device can be designed with less complexity. A high degree of accuracy of the excitation current in the exciter winding is achieved, so that safety buffers can be omitted. A significantly higher efficiency of the externally excited synchronous machine is achieved. Lower material costs are incurred in the power electronics part. Furthermore, the high accuracy of the excitation current leads to a more robust design. Overdimensioning can be eliminated. The fact that capacitive data transmission is not susceptible to electromagnetic interference also contributes to the increased robustness, so that there is a low risk of faulty excitation current and faulty torque of the synchronous machine, such as in an electric drive system of a motor vehicle.

In some embodiments, as already mentioned, it may be provided that the capacitive transmission arrangement may also be designed as a rotor position sensor for determining an angular position of the rotor. The control device may be designed accordingly to also take the angular position into account when controlling the externally excited synchronous machine. In this way, efficient and dynamic torque control can be achieved.

By using the capacitive transmission arrangement as a rotor position sensor, a classic rotor position sensor may be omitted, so that further simplification and a reduction in material expenditure can be achieved. Nevertheless, the rotor position information that is important for the externally excited synchronous machine may still be reliably obtained.

Specifically, it can be provided that one of the transmission device or means, such as the first transmission device or means, comprises a local, non-circumferential capacitive transmitter element and the other transmission device or means, such as the second transmission device or means on the end face of the rotor, comprises an annularly circumferential capacitive transmitter element whose capacitive properties vary along the circumferential direction, wherein the control device and/or the control unit may be designed to determine the angular position using property information describing the variation. In this case, a local, such as at least substantially punctual, capacitive sensor is expediently provided as the first transmission device or means with a corresponding transmitter element that does not extend in the circumferential direction. For example, the transmitter element of the one, such as the first, transmission device or means may have an at least substantially rectangular shape and/or the shape of a short ring segment, for example covering 10° or less, on the radial position of the annular, other transmitter element. This capacitive sensor measures the current capacitance with respect to the second transmitter element of the second transmission device or means, which extends in a ring-like manner on the radial position of the capacitive sensor on the end face and which capacitance changes depending on the angular position of the rotor. The control device, which requires the rotor position information, can determine the angular position therefrom, in addition to transmitted data signals, such as sensor data. Thus, the information and data are available where they are needed. The greatest possible coverage of the transmitter elements in the plane of rotation is ensured.

Specifically, the variation of the capacitive properties may relate to a geometric extension and/or shape of the transmitter element, such as the extension in the radial direction and/or the thickness of a material of the transmitter element. Furthermore, it can also be provided that the variation relates to a material and/or a coating of the transmitter element. These options may be employed in addition.

In other words, there are a number of ways to adapt the capacitive properties of a transmitter element that extends around the entire circumference so that different capacitances result in different angular positions. The transmitter element, which is for example disk-like and is advantageously arranged on the end face of the rotor, is configured in such a way that the capacitance of the transmission path changes depending on the rotor angle. This can be achieved, for example, by the following designs:
variation of the material thickness, i.e., extension in the axial direction, of the transmitter element,
variation of the width, i.e., the extension in the radial direction, of the transmitter element, and
variation of the coating of the transmitter element.

The coating may be a coating with a dielectric in order to vary the capacitance locally.

In some embodiments, it can be provided that at least one of the capacitive transmitter elements may be designed as an electrically conductive, such as metallic, plate. Alternatively or additionally, at least one of the transmitter elements may also be applied as a layer, for example a metal layer.

In addition to the externally excited synchronous machine, the present disclosure also relates to a motor vehicle comprising an externally excited synchronous machine according to the present disclosure. The externally excited synchronous machine in this case is a traction machine of the motor vehicle, i.e., part of an electric (or hybrid) drive system. All statements regarding the externally excited synchronous machine according to the present disclosure can be transferred analogously to the motor vehicle described herein, with which the advantages already mentioned can also be attained.

In a method described herein for operating a synchronous machine according to the present disclosure, it is provided that data transmission between a rotor-external control device of the externally excited synchronous machine and a rotor-side control unit may take place via the capacitive transmission arrangement. In some embodiments, an angular position of the rotor may also be determined by the capacitive transmission arrangement. The statements regarding the externally excited synchronous machine and the motor vehicle also apply to the method accordingly.

### BRIEF DESCRIPTION OF THE SEVERAL VIEWS OF THE DRAWINGS

Further advantages and details of the present disclosure emerge from the embodiments described below and from the drawings.

FIG. 1 shows a schematic diagram of an externally excited synchronous machine.

FIG. 2 shows a schematic view of transmitter elements.

FIG. 3 shows a possible configuration of a rotor-side transmitter element.

FIG. 4 shows a schematic diagram of a motor vehicle.

### DETAILED DESCRIPTION

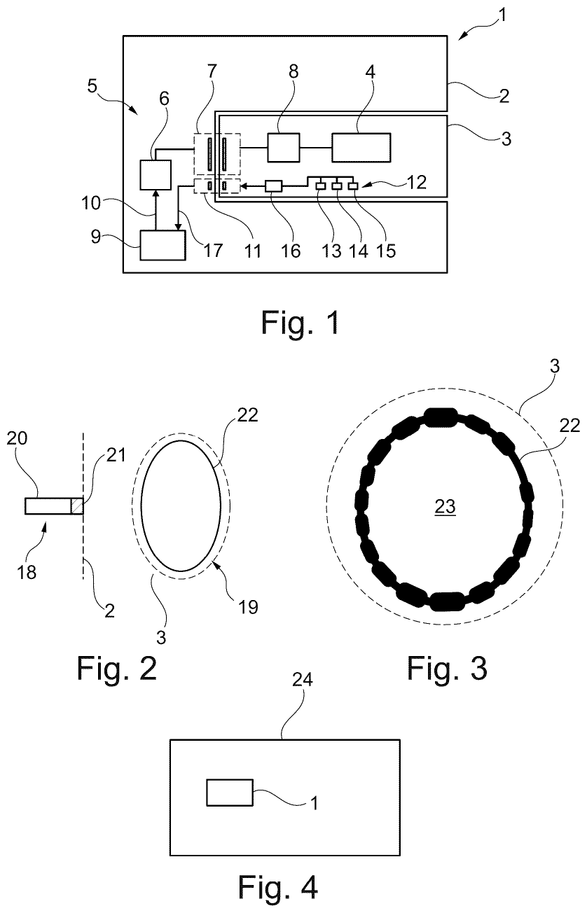

FIG. 1 shows a functional schematic diagram of an externally excited synchronous machine 1. The machine 1 comprises a stator 2 and a rotor 3 with an exciter winding 4. The exciter winding 4 is associated with an inductive transmission system 5 for power, which comprises a fixed inverter 6, an inductive rotary transformer 7 and a rotor-side rectifier 8. Other components, for example for current smoothing, can also be provided.

A rotor-external control device 9 is designed to control the inverter 6 to set a specific excitation current, see arrow 10. In this case, control is carried out on the basis of sensor data which is determined within the rotor 3 and transmitted wirelessly to the control device 9 by a capacitive transmission arrangement 11.

For this purpose, the rotor 3 has rotor sensors 12, in the present case comprising a temperature sensor 13 for measuring the rotor temperature, a rotor current sensor 14 for measuring the rotor current at the exciter winding 4 (i.e., the actual excitation current), and a rotor voltage sensor 15 for measuring a rotor voltage at the exciter winding 4.

The sensor data of these rotor sensors 12 are transmitted by a control unit 16 of rotor 3, designed as a microchip, to the control device 9 via the capacitive transmission arrangement 11, see arrow 17, which can therefore set the excitation current with high precision in the closed control loop. It is also conceivable in principle to transmit current information in the other direction, for example for controlling rotor-internal components, from the control device 9 to the control unit 16 by the capacitive transmission arrangement 11.

In the present case, the capacitive transmission arrangement 11 is also designed as a rotor position sensor, wherein the corresponding angular position of the rotor 3 is also used by the control device 9 when controlling the externally excited synchronous machine 1.

The configuration of the capacitive transmission arrangement 11 provided for this purpose is explained in more detail in FIGS. 2 and 3. FIG. 2 shows schematically that the capacitive transmission arrangement 11 comprises a first transmission device or means 18 of the stator 2 and a second transmission device or means 19 of the rotor 3. First, the fixed transmission device or means 18 comprises in this case a capacitive sensor 20 with a capacitive transmitter element 21 formed locally at the position of the capacitive sensor 20. The capacitive sensor 20 therefore measures at a specific angular position.

In contrast, the capacitive transmitter element 22 of the second transmission device or means 19 is designed in a ring shape on the radial position of the capacitive transmitter element 21, relative to the axis of rotation. FIG. 3 shows this capacitive transmitter element 22 formed on an end face 23 of the rotor 3 in more detail.

The capacitive transmitter element 22, which can be designed as a ring disk or a plate made of conductive material, for example metal, has, as can be seen, a shape and/or extent that varies irregularly in the circumferential direction. This means that its capacitive properties change in the circumferential direction, so that the capacitive sensor 20 measures a different capacitance depending on the angular position of the rotor 3 and can therefore precisely determine the angular position of the rotor 3. Further measures for varying the capacitive properties in the circumferential direction include varying the thickness of the material of the capacitive transmitter element 11 and varying a coating of the capacitive transmitter element 11.

Since the control device 9 has property information describing the variation of the capacitive properties, the control device 9 can determine the angular position from the measured capacitance.

Finally, FIG. 4 shows a schematic diagram of a motor vehicle 24 according to the present disclosure. The motor vehicle 24 comprises an externally excited synchronous machine 1 described herein as a traction machine. This machine forms part of an electric drive system.

German patent application no. 10 2023 131907.8 filed Nov. 16, 2023, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. An externally excited synchronous machine, having a stator and a rotor rotatable relative to the stator, wherein the rotor has an exciter winding for providing a rotor field during operation of the synchronous machine, wherein the synchronous machine has an inductive transmission system for wirelessly transmitting electrical power to the exciter winding for operating the exciter winding, the synchronous machine comprising:
a capacitive transmission arrangement with a fixed first transmission device; and
a second transmission device opposite the first transmission device and arranged on an end face of the rotor for data transmission between a rotor-external control device of the externally excited synchronous machine and a rotor-side control unit.

2. The externally excited synchronous machine according to claim 1, wherein the capacitive transmission arrangement is designed as a rotor position sensor configured to determine an angular position of the rotor.

3. The externally excited synchronous machine according to claim 2, wherein one of the transmission devices comprises a local, non-circumferential capacitive transmitter element and the other transmission device on the end face of the rotor comprises an annularly circumferential capacitive transmitter element whose capacitive properties vary along a circumferential direction, wherein the control device and/or the control unit are/is designed to determine the angular position using property information describing the variation.

4. The externally excited synchronous machine according to claim 3, wherein the variation relates to a geometric extension and/or shape of the capacitive transmitter element.

5. The externally excited synchronous machine according to claim 3, wherein the variation relates to a material and/or a coating of the transmitter element.

6. The externally excited synchronous machine according to claim 3, wherein at least one of the capacitive transmitter elements is designed as an electrically conductive plate.

7. The externally excited synchronous machine according to claim 3, wherein at least one of the capacitive transmitter elements is designed as a metallic plate.

8. The externally excited synchronous machine according to claim 1, wherein the control device is designed to transmit current information for providing an excitation current to the control unit via the capacitive transmission arrangement.

9. The externally excited synchronous machine according to claim 1, wherein the rotor has at least one rotor sensor, wherein the control unit is designed to transmit sensor data of the at least one rotor sensor to the control device via the capacitive transmission arrangement.

10. The externally excited synchronous machine according to claim 9, wherein at least one of the at least one rotor sensor is selected from the group comprising a rotor temperature sensor, a rotor current sensor and a rotor voltage sensor.

11. A motor vehicle, comprising:
an externally excited synchronous machine according to claim 1.

12. A method for operating an externally excited synchronous machine having: a stator and rotor rotatable relative to the stator, wherein the rotor has an exciter winding for providing a rotor field during operation of the synchronous machine, wherein the synchronous machine has an inductive transmission system for wirelessly transmitting electrical power to the exciter winding for operating the exciter winding; a capacitive transmission arrangement with a fixed first transmission device or means; and a second transmission device or means opposite the first transmission device or means and arranged on an end face of the rotor, the method comprising:
transmitting data between a rotor-external control device of the externally excited synchronous machine and a rotor-side control unit via the capacitive transmission arrangement.

13. The method according to claim 12, further comprising:
determining an angular position of the rotor by the capacitive transmission arrangement.
